(19) United States
(12) Patent Application Publication
(10) Pub. No.: US 2018/0165391 A1
(43) Pub. Date: Jun. 14, 2018

(54) STOCHASTIC STRUCTURAL ANALYSIS FOR CONTEXT-AWARE DESIGN AND FABRICATION

(71) Applicant: Disney Enterprises, Inc., Burbank, CA (US)

(72) Inventors: David Isaac William Levin, Toronto (CA); Daniel Dror, Tel Aviv (IL); Timothy Richard Langlois, Seattle, WA (US); Wojciech Matusik, Lexington, MA (US); Ariel Shamir, Jerusalem (IL)

(21) Appl. No.: 15/837,610

(22) Filed: Dec. 11, 2017

Related U.S. Application Data
(60) Provisional application No. 62/433,594, filed on Dec. 13, 2016.

(51) Int. Cl. G06F 17/50

(52) U.S. Cl. CPC G06F 17/5018

(57) ABSTRACT

One embodiment provides a method for identifying a probability that an object will fail, comprising: generating a plurality of force distributions for an object, wherein a force distribution simulates an amount of force on the object resulting from an activity with the object; compressing the plurality of force distributions into a set of conditions; performing an analysis on the set of conditions to determine a stress experienced by the object; and identifying a probability that the object will fail, wherein the identifying comprises determining whether the stress experienced by the object exceeds a yield stress of the object. Other aspects are described and claimed.

### CLAIM FOR PRIORITY

This application claims priority to Provisional Application Ser. No. 62/433,594, filed on Dec. 13, 2016, the contents of which are incorporated by reference in their entirety.

### BACKGROUND

When building or designing objects (e.g., structures, toys, dishes, furniture, etc.) a determination of whether the object will fail under operating conditions is important. For example, when an engineer is designing a bridge, the engineer wants to know the value for the normal or maximum operating forces (e.g., downward forces caused by people or vehicles on the bridge, lateral wind forces, etc.) that will be exerted on the bridge. Using the values for the operating forces, the engineer can then design the bridge to withstand these expected or anticipated operating forces. Commonly structures are designed to withstand a multitude of the expected operating forces to account for unexpected loads and conditions. To determine whether the object will fail, an analysis is typically undertaken using a digital model of the physical structure which indicates whether and how the object will fail under the expected or anticipated forces specified in the analysis, but do not perform analysis based on forces that are unexpected. The designer may modify the design so that the object will not fail under the conditions considered in the analysis.

Many failure-inducing forces, however, fall outside the realm of what is expected or anticipated by the designer. This is particularly true in smaller objects such as toys and product packaging where the object may be subjected to a wide variety of forces in practice. A toy bridge, for example, does not just endure well-characterized pedestrian and vehicle traffic, but may also be dropped, thrown, twisted during storage in ways that are difficult to imagine or predict. Moreover, structurally weaker aesthetic features that may be eliminated from a commercial building are characteristically important to a doll house and so are not eliminated, but the failure modes these aesthetic features present are poorly characterized. Conversely, many failure modes that can be imagined by designers are not realized in real-world object use. Failure modes identified based on intuition and experience are valuable, but may give too much weight to unlikely scenarios. As a result some object features may be over-engineered and hence compromise cost or aesthetic.

### BRIEF SUMMARY

In summary, an embodiment provides a method for identifying a probability that an object will fail, comprising: generating a plurality of force distributions for an object, wherein a force distribution simulates an amount of force on the object resulting from an activity with the object; reducing the plurality of force distributions into a set of sample forces; performing an analysis on the set of sample forces to determine a stress experienced by the object; and identifying a probability that the object will fail, wherein the identifying comprises determining whether the stress experienced by the object exceeds a yield stress of the object.

Another embodiment provides a stochastically analyzed object created using steps of: generating a plurality of force distributions for an object, wherein a force distribution simulates an amount of force on the object resulting from an activity with the object; reducing the plurality of force distributions into a set of sample forces; performing an analysis on the set of sample forces to determine a stress experienced by the object; and identifying a probability that the object will fail, wherein the identifying comprises determining whether the stress experienced by the object exceeds a yield stress of the object.

A further embodiment provides a program product for identifying a probability that an object will fail, comprising: a computer readable storage device having code embodied therewith, the code being executable by the processor and comprising: code that generates a plurality of force distributions for an object, wherein a force distribution simulates an amount of force on the object resulting from an activity with the object; code that compresses the plurality of force distributions into a set of conditions; code that performs an analysis on the set of conditions to determine a stress experienced by the object; and code that identifies a probability that the object will fail, wherein the identifying comprises determining whether the stress experienced by the object exceeds a yield stress of the object.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the embodiments will be pointed out in the appended claims.

### BRIEF DESCRIPTION OF THE SEVERAL VIEWS OF THE DRAWINGS

FIG. 1 illustrates an example method of identifying the probability that an object will fail and optimizing the amount of material for the object.

FIG. 2 illustrates an example set of force scenarios.

FIG. 3 illustrates an example computing device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail to avoid obfuscation. The following description is intended only by way of example, and simply illustrates certain example embodiments.

A common analysis used to make a determination of whether an object will fail is a maximal damage analysis, which may also be known as a “worst-case” scenario analysis. In such an analysis the point of weakness for the object is identified, usually intuitively or experientially. The point of weakness is intended to be a point on the object that will most likely fail when stressed (e.g., hit, bent, pushed, other type of force applied, etc.). Such an analysis is useful for determination of the structural integrity of an object.

A worst-case analysis is rooted in a designer's intuitive speculation about product weak points and forces that will be incurred. Accordingly, the analysis may fail to identify real-world weak points and stresses. As a result, some points may be over-engineered to withstand stresses that are unlikely to occur, while other points are under-engineered because real-world forces were not adequately anticipated. In the case of these objects, designing and building to overcome the maximal damage analysis may cause an aesthetic or financial impact that is not necessary or beneficial to the real-world product performance.

For example, an interior support member of an object may be the weakest point from an analysis standpoint. However, because these interior support members may be protected by other structural elements, the interior support members may be prevented from being damaged during typical usage of the object. A maximal damage analysis fails to take into consideration the real-world usage of the object. Thus, a more useful analysis of failure in such cases is an assessment of failure of the object under normal conditions or operating uses.

One way to perform an analysis on the object under typical conditions includes performing a finite element analysis on all the different portions of the object, both structural and ornamental. A problem with this approach is that finite element analysis is a time-consuming analysis. Performing finite element analysis on every possible scenario and subsection of the object is impractical due to the time that would be required to perform such an analysis. This is especially true for complicated structures and materials. Thus, using typical finite analysis techniques may result in over engineering of a portion of the object that does not actually result in the object being more robust during use. Additionally, when the object is modified to overcome some identified points of weakness, the entire analysis will need to be rerun. The traditional finite element analysis techniques are best used in situations where the loads are well understood and usage conditions are limited. However, if the loads and usage conditions are much more diverse or unknown, for example, in a toy, the traditional finite element analysis techniques may be cumbersome and time-consuming and ultimately may result in a toy that is not more robust than the original design due to unknown or unexpected usage scenarios.

Accordingly, an embodiment provides a system and method for identifying a probability that an object will fail. An embodiment may generate a plurality of force distributions for an object. The force distributions simulate an amount of force that is applied to one or more parts of the object when the object is being used during a normal usage. As an example, the force distribution may simulate the plurality of contact forces on the object when the object is dropped from a predetermined distance. An embodiment may then reduce the plurality of force distributions to a set of sample forces. The set of sample forces includes a reduced basis that represents the force distributions. In other words, the set of sample forces attempts to reduce the amount of force distributions into a smaller sample set that represents the entirety of the plurality of force distributions. The reduction into a set of sample force may be accomplished by mapping the force distributions into a matrix and using a singular value decomposition on the matrix or a representation of the matrix. The simulation may then be performed on these set of sample forces to determine a stress experienced by the object. Thus, rather than performing an analysis on every force distribution, the system performs the analysis on only the set of sample forces, resulting in a system that is much faster.

From the analysis, the system may identify a probability that the object will fail. The identification of the probability that the object will fail may include determining whether the stress, as calculated by the analysis, exceeds a yield stress of the object. Additionally, because the probability is based upon a likely usage scenario, even if not the intended usage scenario, the designer or builder can determine whether the toy should be redesigned to account for that particular usage. For example, the analysis may be performed using a use scenario of the object being dropped from a predetermined height. The analysis may also be performed using a use scenario of the object being thrown. The probability of failure for the object being dropped may be under a particular threshold, while the probability of failure for the object being thrown may be over that threshold. The designer may then decide whether the object should be redesigned to withstand the object being thrown. The systems and methods as described herein provide an identification of how likely an object or a part of the object will fail under use conditions, even if the use conditions are not the use conditions that are intended for the particular object.

Additionally, because the determined failure probabilities are of a format that they can be compared between objects, for example, different designs of the same object, a designer can create more than one different design for an object and evaluate the objects against each other. For example, if a designer could create a toy in a variety of different stances, the designer could compare the probability of failures for the different stances of the toy to determine the stance that has the lowest probability of failure and the aesthetic the designer wants.

The system may also be used to assist in designing an object having an efficient use of material. By iteratively running the analysis and identifying a probability of failure, a designer can vary the amount of material to identify designs that efficiently use material and withstand the typical uses of the object. The system runs the analysis, determines the probability of failure, and identifies if this probability is below a predetermined threshold. If the probability is below the predetermined threshold, the analysis and probability of failure is determined again based upon the object having less material. This iterative process continues until the probability is over the threshold. At this point, the system reverts to the previous design and identifies this design as the optimal design. Thus, the system provides a technique for an optimization of the material to probability of failure analysis. In an embodiment, a design could be optimized for weight, cost, use of recycled material, surface area, topology, or any other factor for iterative design processes.

The illustrated example embodiments will be best understood by reference to the figures. The following description is intended only by way of example, and simply illustrates certain example embodiments.

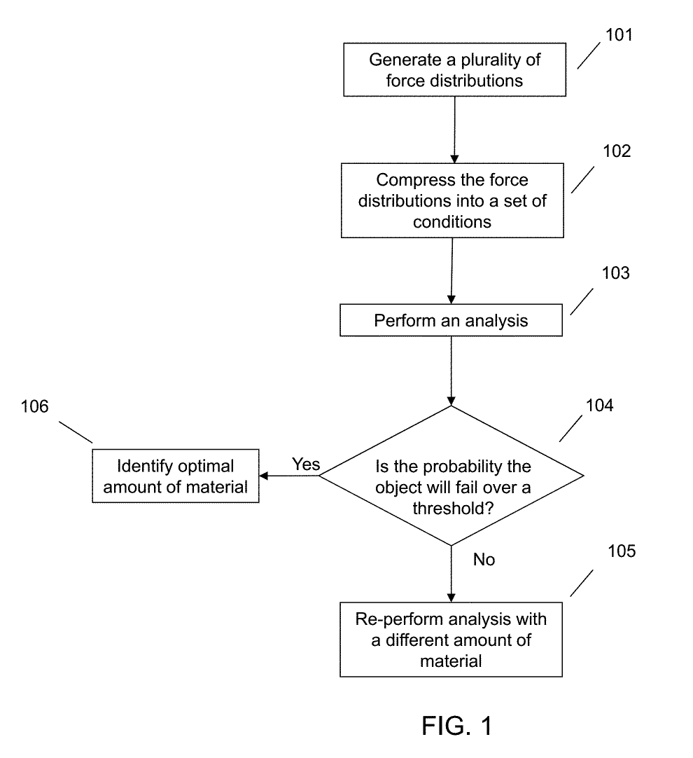

Referring now to FIG. 1, at 101 an embodiment may generate a plurality of force distributions for an object. The force distributions simulate an amount of force on the object that results from an activity with the object (e.g., handling the object, throwing the object, dropping the object, bending the object, etc.). The force distribution may identify the spread of the force on the object and may also identify the parts of the object which are subjected to the highest forces. A force distribution may include a plurality of contact force samples on the object's surface. For example, the force distribution may identify magnitude, direction, and location of contact force on a particular point or area of the object's surface when the object is engaged in the identified activity.

To generate the plurality of force distributions an embodiment may receive a plurality of force scenarios. The force scenarios may include the usage scenario for the object. In other words, the force scenarios may identify the activity that is being performed with the object. The activities may include the typical, intended, or possible usage of the object. For example, if the object is a table, the force scenarios may include a load on top of the table, the table falling from a standing position, the table being dropped, and the like. Thus, the force scenarios are generally input by someone with knowledge of the typical use cases for the object. However, the system may also generate force scenarios. For example, the system may identify one object as being similar to another object that has previously been analyzed. For example, an action figure toy in difference poses may be compared to one another. The system may then apply the same force scenarios to the new object. As another example, the system may use a machine learning approach to identify usage scenarios for the object. The machine learning may use an analysis based upon the historical use of an object, likely areas of potential failure, and the like.

Additional inputs may be provided to generate the force distributions, for example, the geometry of the object, the material of the object, the hardness of the surface the object may strike, and the like. In one embodiment, the inputs may be provided as a three-dimensional (3D) triangle mesh with associated volumetric material assignment. A three-dimensional triangle mesh is a type of polygon mesh in computer graphics that comprises a set of triangles that are connected by common edges or corners. The three-dimensional triangle mesh is generally a visualization of the actual object that is being input to the system, where the visualization includes the object broken into connected triangles. Thus, the geometry of the object may be identified with the corresponding amount and type of material that is found at locations of the object.

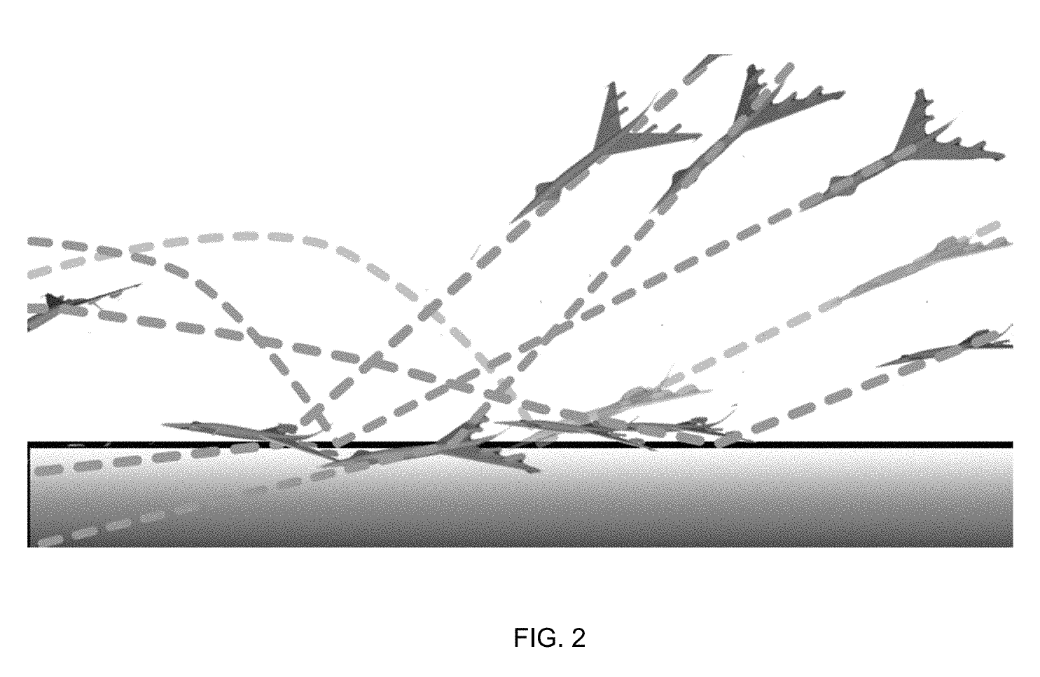

The force distributions may be generated from simulations of the object in the real world using a rigid body simulator to generate a large number of force samples from user supplied scenarios. The simulations of the object in the real world include moving the object to different locations in space and then simulating the different activities that may occur with the object. For example, FIG. 2 shows a toy airplane undergoing different use scenarios, specifically different landing scenarios. The different trajectories identify how the toy airplane could touch the ground and which part of the toy airplane would touch first. By including different scenarios in which an activity results in a contact force (e.g., throwing, dropping, pushing, etc.) and different heights, the system can generate the different force distributions for the different landing scenarios. Once the force distributions have been generated, they may be represented as a matrix of force samples generated from a single initial condition. Depending on the geometry and different usage scenarios, the number of force distributions may be very large, for example, hundreds, thousands, and the like. An object's geometry and inertial properties may be fixed over time and may be simulated as a rigid body. A rigid body simulator may be the function below:

[symbol] =S(ϕ0), where F is a random vector representing the force distribution generated by simulating initial conditions represented by a second random variable ϕ0, a random 12-vector which stores the body's center-of mass position and orientation in the world space, as well as its linear and angular velocities (each represented by 3 scalar values). It is here that we encode real-world context into our algorithm.

Thus, at 102, an embodiment simplifies or reduces the plurality of force distributions into a set of sample forces. Rather than using traditional approaches of performing model reduction on the object geometry which reduces the accuracy of the simulation, the system as described herein reduces the number of force distributions which require analysis. The compression of the plurality of force distributions may result in a set of force samples that is small compared to the original set of force distribution samples, for example, ten samples as opposed to one hundred force distributions. The actual magnitude of reduction is dependent on factors, such as the geometry of the object, the number and variety of use scenarios, and the like. Compressing the force distributions may include applying a singular value decomposition technique. In a system in which the force distributions were represented as a matrix, the singular value decomposition may be applied to the matrix of the force distribution samples. The result of the singular value decomposition may include eigenvectors that represent 95% of the variance in the force distribution data.

In an embodiment, this distribution may be a matrix of force samples F where each column, Fᵢ is a single force sample generated by a single initial condition sampled from ϕ0. For example, each column of F may have the following form:

$${F}_{i} = ( \begin{matrix}{}_{}^{i}{f}{}_{1}^{c} \\ ⋮ \\ {}_{}^{i}{f}{}_{s}^{c} \\ {}_{}^{i}{f}{}_{}^{COM} \\ {}_{}^{i}{τ}{}_{}^{COM}\end{matrix} )$$

where ⁱfₖ^{c} ∈ [symbol] ³ is a contact force sampling acting on the surface of the object mesh, s is the total number of surface points (equal to the number of mesh vertices), where ⁱf^{COM} ∈ [symbol] ³ is the initial force acting on the object's center of mass and is the inertial torque acting on the object's center of mass, and ⁱT^{COM} is the inertial torque acting on the object's center of mass.

At 103, an analysis may be performed on the set of conditions to determine a stress experienced by the object. The analysis may include an analysis on a per element basis. In other words, a piece or subset of the object may be an element and the analysis may be performed on each of these elements. In an embodiment in which eigenvectors were generated, the analysis may be performed on the eigenvectors. The analysis may include a finite element analysis, and, in one embodiment, may include a stochastic finite element analysis. The result of the analysis may include an identification of the stress resulting at various locations of the object, or an element of the object, under the force scenario represented by the analysis.

In an embodiment to map contact force samples from a rigid body representation the finite element mesh a matrix of size 3n×(3s+6) given by

J=[J_{c} J_{com} J_{T}], where

J_{c} ∈ [symbol] ^{3n×3s}, J_{com} ∈ [symbol] ^{3n×3} and J_{T} ∈ [symbol] ^{3n×3}

In this example, Jc is the identity matrix while J_{com}^{T} and J_{T}^{T} are matrix operators which compute the linear and angular velocities at the center of mass of finite element mesh.

In an embodiment, single value decompression (SVD) may be accelerated on the matrix using the QR decomposition of J which yields Q ∈ [symbol] ^{3n×(3s+6)} and R ∈ [symbol] ^{(3s+6)×(3s+6)} where (3s+6)<<3n. Computation may be faster due to the “tall and thin” shape of J. Using a QR decomposition, the following formula may be used:

JF=QRF=QU¹ SV^{T}=USV^{T},

where U′, V, and S may be singular vectors and singular values of RF and U are the right singular vectors of JF, and follows from the orthogonality of both Q and U′. Principal components of JF may be determined by performing SVD on the much smaller matrix RF reducing computation time.

In an embodiment, a mean sample vector and principal components form a reduced basis for force samples as F̅ⁱα where ⁱα=F̅^{T} Fᵢ. The i^{th} force sample may be represented as: ⁱσ=CBK⁻¹ F̅ⁱ α, wherein stress samples may be computed using a number of linear solves equal to the number of columns in F̅.

Using the resulting stresses an embodiment may identify the probability that the object will fail. The probability that the object will fail may include determining whether the stress experienced by the object exceeds a yield stress of the object. The yield stress of the object identifies the amount of stress the object can withstand at a particular location before failing. Thus, if the stress experienced by the object exceeds the yield stress of the object, the object will fail. Accordingly, the probability that the object will fail is related to the probability that the object will experience the stress identified through the analysis. Accordingly, the system may approximate a probability density function (PDF) using a piecewise linear function. The PDF may then be used to compute the cumulative distribution function (CDF), which can then be solved to identify the probability that the object will fail. The system may also generate a spatially varying map of failure probabilities for elements of the object. For example, the system may provide a map of the object which identifies the probability of failure for points on the object. In other words, the object may be shown as a heat-type map which shows higher probabilities of failure as different colors.

If the maximum von Mises stress in an element exceeds the yield stress, the element may fail. The probability of failure may be related to the probability that an object will experience a given maximum von Mises stress. This probability density function (PDF) may be approximated using a piecewise linear function. A histogram, H, may be calculated which requires binning the maximum von Mises stress of each stress sample, given by ⁱ\tilde{σ}=max (σ̅(ⁱσ)). Max is the component-wise maximum taken over the global vector of per-element von Mises stresses, computed by the function \tilde{σ}^{e}([σ^{e}). Then P(\tilde{σ}) may be discretized using a 1-dimensional finite element grid where the e^{th} element is equipped with k finite element shape functions ψₗ^{e}(x). H may be represented as:

$$H ( x ) = {\sum }_{i = 1}^{{N}_{s}} δ ( x - {}^{i} \tilde{σ} ) ,$$

where δ(y) is a discrete Dirac delta, defined by:

$$δ ( y ) = \{ \begin{matrix}\frac{1}{{N}_{s}} & y = 0 \\ 0 , & otherwise\end{matrix} .$$

In each finite element of P(\tilde{σ}) an estimate of the distribution may be a linear combination of shape functions, P^{e}(\tilde{σ})=Σₗ₌₁^{k} αₗψₗ^{e}(\tilde{σ}), where aare unknown coefficient values. These values may be estimated in a Galerkin fashion. Each element, e, in a probability space discretization emits two linear equations of the form:

$${\sum }_{l = 1}^{k} {a}_{l} {\int }_{y} {ψ}_{g}^{e} ( y ) {ψ}_{l}^{e} ( y ) {dy}^{e} = {\int }_{\tilde{σ}} {ψ}_{g}^{e} ( y ) H ( y ) dy ,$$

where g indexes the element shape functions and may be integrated over the range of \tilde{σ} covered by element e.

In an embodiment, due to the properties of the discrete Direc delta, we can simplify this equation to:

$${\sum }_{l = 1}^{k} {a}_{l} {\int }_{{\tilde{σ}}^{e}} {ψ}_{g}^{e} ( y ) {ψ}_{l}^{e} ( y ) dy = {\sum }_{i = 1}^{{N}_{a}} {ψ}_{g}^{e} ( {}^{i} \tilde{σ} ) \frac{1}{{N}_{a}} ,$$

which may be assembled into a tridiagonal linear system of the form Na=b, where a is the stacked vector of coefficients a₁. Due to its sparse nature this system may be solved efficiently. By concatenating all element shape functions into a matrix Ψ(y) we may express the entire PDF using the simple equation: P(\tilde{σ})=Ψ(\tilde{σ})N⁻¹ b₁. The failure probability map can then be used by designers and/or builders to determine whether they want to change the design of the object.

Additionally, when the time for analysis of the system is significantly reduced, the system as described herein can be used to iteratively optimize the design of an object. The optimization may include adding or removing material, changing the type of material, altering angles or joints, or the like from an initial object design in order to optimize its structure. Accordingly an embodiment may iteratively perform the steps of generating a plurality of force distributions, compressing the force distributions, performing an analysis for the set of conditions, and identifying a probability. Iterations may be based on design variations and the result of multiple iterations is a set of failure probability maps associated with iterations that can be compared by a product designer to identify a preferred design.

At the end of each iteration, at 104, an embodiment may determine whether the probability of failure has exceeded a predetermined threshold, which may be set by a user or the system. If the probability of failure has not exceeded the predetermined threshold, the system may re-perform the structural analysis with a different amount of material at 105. Once the probability of failure exceeds the predetermined threshold, the system may identify the optimal amount of material at 106. The optimal amount of material may include the amount of material that was included for the iteration preceding the iteration that caused the probability to exceed the threshold.

In an embodiment, if the maximum von Mises stress stays below the yield stress for a given material then the object is predicted to not break. This may be expressed as P(\tilde{σ}<\tilde{σ})ⁱ, where \hat{σ} is the yield stress for a given material. This may be the CDF of the PDF computed. A piecewise PDF may be easily modified to directly compute the CDF by inserting an appropriate integral, for example:

P (\tilde{σ}<\hat{σ})=∫₀^{\hat{σ}}Ψ(y)N⁻¹ bdy,

Since the Ψ matrix depends on y, the matrix may be integrated quickly as a preprocess. This may allow a CDF representation that is easier to differentiate. Then a single linear system solve, followed by a binary search across a finite element probability grid allows efficient computation of the probability that an object will not break. A probability that an object will break may be calculated as a complement by:

P_{fail} (\tilde{σ}<\hat{σ})=1−P(\tilde{σ}<\hat{σ}).

In an embodiment, computing P_{fail} may solve a forward analysis problem. For any input mesh, accompanying material assignment and collection of usage scenarios may estimate the probability of object failure. Computation a spatially varying map of failure probabilities using our stress samples may be performed. For any point in an object, x ∈ R³, we may compute local probability of failure, P_{fail}(x), by evaluation on the per-element von Mises stress samples i.e., without taking the max over the entire object. We may display both P_{fail} and the spatially varying P_{fail}(xi) to a designer or engineer, allowing them to make design decisions guided by a measure of real world robustness (as described above). One of the features of failure probability as a metric is that it is comparable between objects. This induces a “reliability ordering” on our designs which allows designers to explicitly trade-off reliability for artistic considerations.

In addition to being used as a guide for designers and engineers, our failure probabilities can also assist in guiding topology optimization. Topology optimization involves either adding or removing material from an initial object design in order to optimize its structure. There are many ways in which topology optimization could utilize failure probabilities but in this paper we explore a specific case of object weight reduction. We minimize the amount of material in each element while maintaining the probability of failure under a given threshold. This can be formulated as:

$${w}^{*} = arg {min}_{w} {\sum }_{e = 1}^{{N}_{el}} {w}_{e} {\int }_{{Ω}_{e}}^{ } {ρ}_{e} d Ω , \\ s . t . P ( \tilde{σ} < \hat{σ} ) > Θ$$

$$Ku = f$$

$$0 < {ω}_{min} \leq w \leq 1 ,$$

where ωₑ ∈ [0, 1] is a “fill ratio”, for the e^{th} finite element where 0 indicates the element is completely empty, ω is the stacked vector of all ωₑ, Ωₓ and ρₑ are, respectively, the volume occupied by and the density of the e^{th} finite element. We use to constrain the robustness of the object being optimized. This gives the designer an intuitive handle for trading between the amount of material used during fabrication and the durability of the object.

Like our forward design problem, our topology optimization scheme takes a triangle mesh with volumetric material assignment, and a usage scenario as input. Additionally, one must specify the failure threshold θ. The output, ω* describes which elements in the original finite element mesh are either full or have been removed to save weight.

Computing the gradient of our probability functions is a computationally difficult task given that we require the derivative with respect to each wₑ where |w| is equal to the total number of finite elements in our computational mesh. The first step in making this derivative tractable is to rephrase P(\tilde{σ}<\hat{σ}) by normalizing with respect to the yield stress allowing us to re-express

$${P}_{\tilde{σ}} ( \tilde{σ} < \hat{σ} ) > Θ as {P}_{\tilde{σ}} ( \frac{\tilde{σ}}{\hat{σ}} < 1 ) > Θ .$$

The standard von Mises stress may have a singularity when used for topology optimization so we use a modified von Mises stress measure to avoid this which is given by:

$${S}^{e} ( {σ}^{e} ) = {w}_{e}^{1 / 2} \frac{{\tilde{σ}}^{e} ( {σ}^{e} )}{\hat{σ}} .$$

We then use the whole object maximum, S=max (S (α)) to compute P (S<1)>θ as a stable replacement for our previous probability. Because we use a piecewise linear representation for the CDF we can easily evaluate its derivative. After normalization, our CDF becomes: P(S<1)=∫₀¹ Ψ (y) N⁻¹ bdy, where N and b are computed using S. The derivative of this equation with respect to ω is given by:

$$\frac{\partial P ( S < 1 )}{\partial w} = {\int }_{0}^{1} Ψ ( y ) {N}^{- 1} \frac{\partial b}{\partial w} dy , , where \frac{\partial b}{\partial w}$$

can be derived to be:

$$\frac{\partial b}{\partial w} = \frac{1}{{N}_{s}} {\sum }_{i = 1}^{{N}_{s}} \frac{\partial {ψ}_{s}^{e}}{\partial S} \frac{\partial S}{\partial w} .$$

This requires the derivative of our shape functions, which are easy to compute, and the derivatives of our samples with respect to the fill parameters. Naively, one could use finite differencing to compute this gradient, but recall that |w| is large. Since each finite difference solve would require a Finite Element solve this solution is clearly not viable. Instead we show how to drastically reduce the number of solves needed to compute this gradient using the Adjoint method.

Our first major road block in computing

$$\frac{\partial S}{{\partial w}_{.}}$$

arises because S=max(S (¹σ)). The max function does not have a smooth derivative and so instead we use a common substitution, the L^{p} norm. As p approaches infinity Lapproaches max. Thus we must now evaluate:

$$\frac{\partial S}{\partial w} = {[ {\sum }_{e = 1}^{{N}_{el}} {S}^{ep} ]}^{\frac{1}{p} - 1} {\sum }_{e = 1}^{{N}_{el}} {S}^{e ( p - 1 )} ( \frac{\partial {S}^{e}}{\partial w} ( {}_{ }^{i}{σ}{}_{ }^{e} ) + \frac{\partial {S}^{e}}{\partial {\tilde{σ}}^{e}} \frac{\partial {\tilde{σ}}^{e}}{\partial {}^{i} σ} \frac{\partial {}^{i} σ}{\partial w} ) , ,$$

where we have found that p=8 works well. Here all derivatives except for

$$\frac{\partial {σ}_{i}}{\partial w}$$

have easier analytical solutions.

In an embodiment, for the per-sample evaluation of the stress gradient the following formula may be used:

$$\frac{\partial {σ}_{i}}{\partial w} = - {CBK}^{- 1} \frac{\partial K}{\partial w} \overline{U} {}^{i} α + {CBK}^{- 1} \frac{\partial \overline{F}}{\partial w} {}^{i} α + CB \overline{U} \frac{\partial {}^{i} α}{\partial w} , where \\ \overline{U} = {K}^{- 1} \overline{F} , \frac{\partial K}{\partial w}$$

is a sparse, third order tensor representing the derivative of the finite element stiffness matrix with respect to the fill in parameters,

$$\frac{\partial \overline{F}}{\partial w}$$

is the derivative of our reduced force basis and

$$\frac{\partial {}^{i} α}{\partial w}$$

is the derivative of the sample coordinates in that space.

We can exploit the fact that force samples are generated by a rigid body simulation, and are thus only dependent on the center-of-mass and moments-of-inertia of the objects current state. This allows us to evaluate

$$\frac{\partial F}{\partial w} and \frac{\partial {}^{i} α}{\partial w}$$

using a total of 18 finite differences per sample. Because rigid body simulation of a single object is fast, and because sampling is parallel, this step is relatively efficient.

In an embodiment, the gradient formula may be reduced such that

$$\frac{\partial P ( S < 1 )}{\partial w}$$

may be expressed as:

$$\frac{\partial P ( S < 1 )}{\partial w} = {\sum }_{i = 1}^{{N}_{s}} {a}_{i} ( {b}_{i} + \frac{\partial {}^{i} α}{\partial w} {}_{}^{T}{c}{}_{i}^{} ) , , where$$

$${a}_{i} = {\int }_{0}^{1} Ψ ( y ) {dy [ {\sum }_{e = 1}^{{N}_{el}} {S}^{ep} ]}^{\frac{1}{p} - 1} , {b}_{i} = {\sum }_{e = 1}^{{N}_{el}} {S}^{e ( p - 1 )} \frac{\partial {S}^{e}}{\partial w} ( {}_{ }^{i}{σ}{}_{ }^{e} ) and {c}_{i} = {\sum }_{e = 1}^{{N}_{el}} {S}^{e ( p - 1 )} \frac{\partial S}{\partial {\tilde{σ}}^{e}} \frac{\partial {σ}^{e}}{\partial {}^{i} σ} .$$

or also expressed by:

$$\frac{\partial {P}_{\tilde{σ}}}{\partial w} = ( {K}^{- 1} X ) \text{:} \frac{\partial K}{\partial w} + ( {K}^{- 1} Y ) \text{:} \frac{\partial \overline{F}}{\partial w} + x + b where$$

$$X = ( {\sum }_{i = 1}^{{N}_{s}} {B}^{T} {C}^{T} {c}_{i} ⊗ {}^{i} α ) {\overline{U}}^{T} , Y = ( {\sum }_{i = 1}^{{N}_{s}} {B}^{T} {C}^{T} {c}_{i} ⊗ {}^{i} α ) , \\ x = {\sum }_{i = 1}^{{N}_{s}} \frac{{\partial }^{i} α}{\partial w} {}_{}^{T}{\overline{U}}{}_{}^{T} {B}^{T} {C}^{T} {c}_{i} and b = {\sum }_{i = 1}^{{N}_{s}} {a}_{i} {b}_{i} .$$

Notice that X=YU^{T} and Y ∈ [symbol] ^{σ×N}^{_{b}} where N_{b} is the number of reduced space basis vectors. Thus K⁻¹ using only N_{b} linear solves to compute the entire gradient and makes stochastic topology optimization possible.

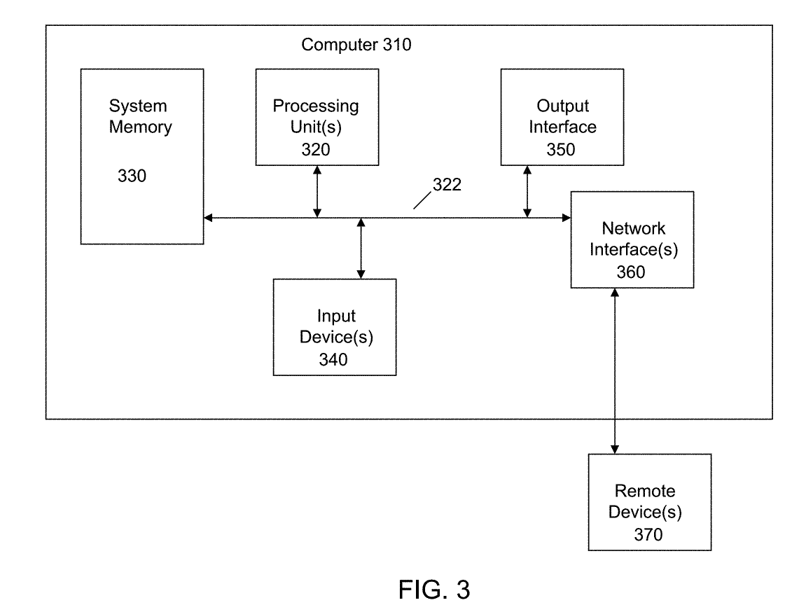

It will be readily understood by those having ordinary skill in the art that a variety of computing devices may be employed in implementing various embodiments. For example, FIG. 3 depicts an example information handling device 310 that may be used to implement embodiments herein. For example, the system of FIG. 3 may be used to monitor and analyze the user's compliance with a compliance step. The system of FIG. 3 may also be used to identify a user, the operational task to be performed by the user, the tasks to be completed by the user, and the like.

Components of information handling device 310 may include, but are not limited to, at least one processing unit 320, a system memory 330, and a system bus 322 that couples various system components including the system memory 330 to the processing unit(s) 320. The information handling device 310 may include or have access to a variety of computer readable media. The system memory 330 may include computer readable storage media in the form of volatile and/or nonvolatile memory such as read only memory (ROM) and/or random access memory (RAM). By way of example, and not limitation, system memory 330 may also include an operating system, application programs, other program modules, and program data.

A user can interface with (for example, enter commands and information) the information handling device 310 through input devices 340. A monitor or other type of device can also be connected to the system bus 322 via an interface, such as an output interface 350. In addition to a monitor, information handling devices may also include other peripheral output devices. The information handling device 310 may operate in a networked or distributed environment using logical connections (network interface 360) to other remote computers, databases, cameras, sensors or devices (remote device(s) 370). The logical connections may include a network, such as a local area network (LAN) or a wide area network (WAN), or a cellular network, but may also include other networks.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method for identifying a probability that an object will fail, comprising:
generating a plurality of force distributions for an object, wherein a force distribution simulates an amount of force on the object resulting from an activity with the object;
reducing the plurality of force distributions into a set of sample forces;
performing an analysis on the set of sample forces to determine a stress experienced by the object; and
identifying a probability that the object will fail, wherein the identifying comprises determining whether the stress experienced by the object exceeds a yield stress of the object.

2. The method of claim 1, wherein the generating a plurality of force distributions comprises using a rigid body simulation.

3. The method of claim 1, wherein the generating a plurality of force distributions comprises receiving a plurality of force scenarios and simulating the force scenarios.

4. The method of claim 1, wherein the compressing the plurality of force distributions comprises applying a singular value decomposition.

5. The method of claim 4, comprising creating a matrix comprising the plurality of force distributions and applying the singular value decomposition to the matrix.

6. The method of claim 5, wherein the performing the analysis comprises performing the analysis on eigenvectors resulting from the singular value decomposition of the matrix.

7. The method of claim 1, wherein the performing an analysis comprises performing a stochastic finite element analysis.

8. The method of claim 1, wherein the identifying the probability comprises identifying the probability for a subsection of the object.

9. The method of claim 1, comprising identifying an amount of material for construction of the object by conducting a topology optimization.

10. The method of claim 9, wherein the conducting a topology optimization comprises iteratively performing the steps of: generating a plurality of force distributions, reducing the plurality of force distributions, performing an analysis, and identifying a probability, on the object, wherein at each iteration an amount of material for the object is changed.

11. The method of claim 10, wherein an optimal material amount for the object is identified using the topology optimization when the identified probability reaches a predetermined threshold.

12. A stochastically analyzed object created using steps of:
generating a plurality of force distributions for an object, wherein a force distribution simulates an amount of force on the object resulting from an activity with the object;
reducing the plurality of force distributions into a set of sample forces;
performing an analysis on the set of sample forces to determine a stress experienced by the object; and
identifying a probability that the object will fail, wherein the identifying comprises determining whether the stress experienced by the object exceeds a yield stress of the object.

13. The stochastically analyzed object of claim 12, wherein the generating a plurality of force distributions comprises using a rigid body simulation.

14. The stochastically analyzed object of claim 12, wherein the generating a plurality of force distributions comprises receiving a plurality of force scenarios and simulating the force scenarios.

15. The stochastically analyzed object of claim 12, wherein the compressing the plurality of force distributions comprises creating a matrix comprising the plurality of force distributions and applying a singular value decomposition to the matrix.

16. The stochastically analyzed object of claim 12, wherein the performing an analysis comprises performing a stochastic finite element analysis.

17. The stochastically analyzed object of claim 12, wherein the identifying the probability comprises identifying the probability for a subsection of the object.

18. The stochastically analyzed object of claim 12, comprising identifying an amount of material for constructions of the object by conducting a topology optimization.

19. The stochastically analyzed object of claim 18, wherein the conducting a topology optimization comprises iteratively performing the steps of: generating a plurality of force distributions, compressing the plurality of force distributions, performing an analysis, and identifying a probability, on the object, wherein at each iteration an amount of material for the object is changed.

20. A program product for identifying a probability that an object will fail, comprising:
a computer readable storage device having code embodied therewith, the code being executable by the processor and comprising:
code that generates a plurality of force distributions for an object, wherein a force distribution simulates an amount of force on the object resulting from an activity with the object;
code that compresses the plurality of force distributions into a set of conditions;
code that performs an analysis on the set of conditions to determine a stress experienced by the object; and
code that identifies a probability that the object will fail, wherein the identifying comprises determining whether the stress experienced by the object exceeds a yield stress of the object.
